(19) United States
(12) Patent Application Publication
(10) Pub. No.: US 2015/0362872 A1
(43) Pub. Date: Dec. 17, 2015

(54) IMAGE FORMING METHOD

(71) Applicant: Konica Minolta, Inc., Tokyo (JP)

(72) Inventors: Takaki KAWAMURA, Tokyo (JP); Yasuko UCHINO, Tokyo (JP); Junya ONISHI, Tokyo (JP); Natsuko FUJISAKI, Tokyo (JP); Anju HORI, Tokyo (JP); Junya UEDA, Tokyo (JP); Ikuko SAKURADA, Tokyo (JP)

(21) Appl. No.: 14/722,952

(22) Filed: May 27, 2015

(30) Foreign Application Priority Data
Jun. 12, 2014 (JP) 2014-121353

(51) Int. Cl. G03G 9/00

(52) U.S. Cl. CPC G03G 15/20; G03G 15/01

(57) ABSTRACT

An image forming method includes: disposing a white toner image of a white toner and a colored toner image of a colored toner in the order named; and heat-fixing these toner images to a recording medium. The white toner and the colored toner satisfy the following relational expressions (1) and (2). In the expressions, G′0(w), G′10(w) and G′20(w) respectively represent storage moduli of the white toner 0 seconds after, 10 seconds after and 20 seconds after start of time variance measurement, and G′0(c), G′10(c) and G′20(c) respectively represent storage moduli of the colored toner 0 seconds after, 10 seconds after and 20 seconds after the start of time variance measurement. The storage moduli are obtained by the time variance measurement at 90° C.

(G′10(c)/G′0(c))<(G′10(w)/G′0(w)) Relational Expression (1):

G′20(w)<G′20(c) Relational Expression (2):

### FIELD OF THE INVENTION

The present invention relates to an image forming method.

### DESCRIPTION OF THE RELATED ART

In the field of toners for developing electrostatic images (hereinafter may be simply referred to as “toners”) used in electrophotographic image formation, there have been developments to meet various demands from the market. In particular, because the number of types of recording media on which images are formed has being increasing, demands from the market on toners for these various types of recording media is very high.

More specifically, for example, when an image is formed on a no white recording medium such as color paper (paper with any of colors except white) or a transparent film, the full-color toner, namely, four colored toners of yellow toner, magenta toner, cyan toner and black toner, is not enough for the color(s) of the image to come out well. Hence, there has been proposed to use white toner as the fifth toner to form a base layer serving as the background. (Refer to, for example, Japanese Patent Application Publication No. 2006-220694.)

Because the base layer formed of the white toner is white, in terms of hiding power, ideally, all of the light entering the base layer should be scattered. Hence, there has been studied to improve hiding characteristics of the white toner, which forms the base layer. (Refer to, for example, Japanese Patent Application Publication Nos. 1-105962 and 2000-56514.)

However, improvement in the hiding characteristics of the white toner only is not enough to realize speed-up of image formation and high image quality and wide color gamut of produced visible images, which are especially demanded in the production market. Hence, there have been many studies to design characteristics of the white toner giving consideration to the colored toner(s) and a fixing system. (Refer to, for example, Japanese Patent Application Publication Nos. 2006-209090 and 2012-177763.)

More specifically, there is proposed in Japanese Patent Application Publication No. 2006-209090 to prevent the white toner from excessively soaking into a recording medium by controlling storage moduli at a temperature of a fixing nip of the white toner and the colored toner, thereby improving gloss uniformity on the surface of a produced visible image and accordingly increasing image quality.

Further, there is proposed in Japanese Patent Application Publication No. 2012-177763 to reduce gloss difference between an image part of the colored toner and an image part (background part) of the white toner in a produced visible image by controlling a ratio of the endothermic quantity derived from a crystalline resin of the white toner to the endothermic quantity derived from a crystalline resin of the colored toner, thereby increasing image quality.

However, none of these proposals based on the results of the studies on designing the characteristics of the white toner satisfies speed-up of image formation or wide color gamut of produced visible images, which are demanded in the current production market.

The present inventors have studied after studied to meet the demands in the current production market, namely, speed-up of image formation and wide color gamut of produced visible images. As a result of that, the present inventors have found out that at a fixing step of heat-fixing a stack of a white toner image and a colored toner image (hereinafter may be referred to as a “toner image stack”) to a recording medium, color mixture occurs at the interface between the white toner image and the colored toner image, which decreases color development of the fixed image (visible image), namely, decreases color development of the colored toner image, and accordingly cannot produce a desired color tone. Then, the present inventors have found out that the white toner and the colored toner need low-temperature fixability for speed-up of image formation and need high color developability for wide color gamut of produced visible images.

### BRIEF SUMMARY OF THE INVENTION

The present invention has been conceived in view of the above circumstances, and objects of the present invention include providing an image forming method capable of, when a visible image composed of a colored toner image disposed on a white toner image is formed, performing fixing at a low temperature and producing a visible image the color(s) of which comes out very well.

According to an aspect of the present invention, there is provided an image forming method including: disposing a white toner image of a white toner containing a binder resin and a white colorant and a colored toner image of a colored toner containing a binder resin and a colored colorant in the order named; and heat-fixing the white toner image and the colored toner image, which is disposed on the white toner image, to a recording medium, wherein the white toner and the colored toner satisfy the following relational expressions (1) and (2):

(G′10(c)/G′0(c))<(G′10(w)/G′0(w)); and Relational Expression (1):

G′20(w)<G′20(c), Relational Expression (2):

wherein G′0(w) represents a storage modulus of the white toner 0 seconds after start of time variance measurement, G′10(w) represents a storage modulus of the white toner 10 seconds after the start, G′20(w) represents a storage modulus of the white toner 20 seconds after the start, G′0(c) represents a storage modulus of the colored toner 0 seconds after the start, G′10(c) represents a storage modulus of the colored toner 10 seconds after the start, and G′20(c) represents a storage modulus of the colored toner 20 seconds after the start, the storage moduli being obtained by the time variance measurement at 90° C.

In the image forming method of the present invention, preferably the white toner satisfies the following relational expression (3):

0.88<G′10(w)/G′0(w)<1.00. Relational Expression (3):

In the image forming method of the present invention, preferably the G′20(w) is 2.4×10⁵ Pa or less.

In the image forming method of the present invention, preferably each of the binder resin of the white toner and the binder resin of the colored toner contains a crystalline resin.

In the image forming method of the present invention, preferably the recording medium is a film or synthetic paper.

### DETAILED DESCRIPTION OF THE INVENTION

Hereinafter, an image forming method of the present invention is detailed.

An image forming method of the present invention includes: stacking a white toner image of a white toner and a colored toner image of a colored toner in this order; and heat-fixing the white toner image and the colored toner image of the stack of the toner images (i.e., the toner image stack) to a recording medium. More specifically, the image forming method includes, for example, the following steps (1) to (5).
(1) a charge step of charging the surface of an image holder;
(2) an exposure step of performing exposure so as to form an electrostatic latent image on the image holder;
(3) a development step of developing the electrostatic latent image formed on the image holder with a developer containing a toner so as to form a toner image;
(4) a transfer step of transferring the toner image formed on the image holder to a recording medium; and
(5) a fixing step of heat-fixing the toner image transferred to the recoding medium.

At the step (4) of the transfer step, a toner image stack composed of a white toner image and a colored toner image stacked in this order is formed on a recording medium.

At the step (5) of the fixing step, the white toner image and the colored toner image of the toner image stack formed on the recording medium are heat-fixed at the same time.

The white toner used in the image forming method of the present invention contains at least a binder resin and a colorant for white (hereinafter may be referred to as a “white colorant”) and may also contain, as needed, other internal additives or external additives such as a release agent. On the other hand, the colored toner contains at least a binder resin and a colorant for not white but a color (hereinafter may be referred to as a “colored colorant”) and may also contain, as needed, other internal additives or external additives such as a release agent. Note that the “colored” (or “color”) in this application means any of colors (yellow, magenta, cyan, black, etc.) except white.

The colored toner image of the colored toner may be formed of one colored toner, or may be formed of two or more colored toners as a colored toner image of a secondary color (two colored toners mixed), a tertiary color (three colored toners mixed) or the like.

In the image forming method of the present invention, the white toner has a smaller storage modulus variation from the start of time variance measurement to 10 seconds after the start than the colored toner and also has a smaller storage modulus 20 seconds after the start than the colored toner. The storage moduli are obtained by time variance measurement at 90° C.

More specifically, the white toner and the colored toner satisfy the following Relational Expressions (1) and (2), wherein G′0(w) represents a storage modulus of the white toner 0 seconds after the start of time variance measurement, G′10(w) represents a storage modulus of the white toner 10 seconds after the start, G′20(w) represents a storage modulus of the white toner 20 seconds after the start, G′0(c) represents a storage modulus of the colored toner 0 seconds after the start, G′10(c) represents a storage modulus of the colored toner 10 seconds after the start, and G′20(c) represents a storage modulus of the colored toner 20 seconds after the start, the storage moduli being obtained by the time variance measurement at 90° C.

As long as the white toner and the colored toner of the toner image stack satisfy Relational Expressions (1) and (2), the white toner may have a larger storage modulus, which is obtained by time variance measurement at 90° C., more than 20 seconds after the start of the time variance measurement than the colored toner.

(G′10(c)/G′0(c))<(G′10(w)/G′0(w)) Relational Expression (1):

G′20(w)<G′20(c) Relational Expression (2):

When the colored toner image of the toner image stack is formed of two or more colored toners, the “G′10(c)/G′0(c)” in the above Relational Expression (1) is the largest “G′10(c)/G′0(c)” which a colored toner of the colored toners has, and the “G′20(c)” in the above Relational Expression (2) is the smallest “G′20(c) ” which a colored toner of the colored toners has.

The storage modulus G′t(w) of the white toner and the storage modulus G′t(c) of the colored toner (wherein t in each of G′t(w) and G′t(c) represents the time elapsed from the start of the measurement, the t being 0 [seconds after], 10 [seconds after] or 20 [seconds after].) are measured as follows.

First, a measurement target toner (the white toner or the colored toner, to be specific) is pelleted with a tablet forming device so that pellets having a thickness of 2.0 mm are prepared as a toner sample for measuring the storage modulus.

Next, the prepared toner sample is set on a parallel plate having a diameter of 10 mm with a viscoelasticity measuring device MCR-302 (from Anton-Paar GmbH) under the environment condition of a temperature of 25° C. Then, the toner sample is heated by increasing the temperature to a temperature (e.g., 95° C.) being equal to or higher than a storage modulus measurement temperature at a temperature rising rate of 10° C./min as a temperature rising condition, and crushed and chucked until the thickness becomes 1.5 mm. Thereafter, the toner sample is cooled to 90° C. at a temperature falling rate of 10° C./min as a temperature falling condition, and the viscoelasticity measurement starts with the following measurement conditions: a measurement temperature of 90° C., a distortion rate of 5%, a frequency of 10 Hz, and a measurement time of 300 seconds. Then, the storage modulus is measured at the start of the measurement (0 seconds after), 10 seconds after the start of the measurement and 20 seconds after the start of the measurement.

When the white toner and the colored toner satisfy the above Relational Expressions (1) and (2), the white toner has higher sharp meltability and higher low-temperature fixability than the colored toner. Hence, in the toner image stack, the white toner quickly melts prior to the colored toner, and a white toner image is formed on a recording medium, which prevents cracks and gaps which the colored toner can enter from being formed in the white toner image. Thus, the white toner has more excellent thermal responsiveness than the colored toner, which prevents color mixture at the interface between the white toner image and the colored toner image from occurring. Consequently, in a formed visible image (fixed image), the colored toner image has excellent saturation, and accordingly a visible image the color(s) of which comes out very well can be produced.

The above is detailed hereinafter. First of all, the storage modulus of a toner is a value indicating degree of softness of the toner, and the smaller the value is, the softer the toner is.

The storage modulus of a toner is usually smaller as the measurement time proceeds. Hence, a ratio of the storage modulus G′10(w) to the storage modulus G′0(w) (G′10(w)/G′0(w)) (hereinafter may be referred to as a “white toner storage modulus early-stage variation ratio”) and a ratio of the storage modulus G′10(c) to the storage modulus G′0(c) (G′10(c)/G′0(c)) (hereinafter may be referred to as a “colored toner storage modulus early-stage variation ratio”) are larger as the storage modulus variation from the start of the measurement to 10 seconds after the start is smaller.

Further, in the storage modulus measurement, a toner sample is heated to the storage modulus measurement temperature (90° C., to be specific) or higher before the measurement starts. Hence, the viscoelasticity varies by the heating. When, however, the toner (measurement target toner) of the toner sample has sharp meltability and low-temperature fixability, the storage moduli at the start of the measurement (0 seconds after), 10 seconds after the start and 20 seconds after the start are approximately the same; that is, it does not happen that the storage modulus greatly varies as the measurement time proceeds.

Thus, when the white toner and the colored toner satisfy the above Relational Expression (1), the white toner has higher sharp meltability and more excellent low-temperature fixability than the colored toner.

Further, when the white toner and the colored toner satisfy the above Relational Expression (2), the white toner is softer and more easily flows on a recording medium than the colored toner, or to put it the other way around, the colored toner is solider than the white toner. Hence, on a recording medium, a white toner image is formed prior to a colored toner image, and also cracks and gaps which the colored toner can enter are prevented from being formed in the white toner image.

In the toner image stack, as represented by the above Relational Expression (1), the white toner storage modulus early-stage variation ratio is required to be larger than the colored toner storage modulus early-stage variation ratio. The magnitude of the white toner storage modulus early-stage variation ratio to the colored toner storage modulus early-stage variation ratio, namely, a ratio of the white toner storage modulus early-stage variation ratio to the colored toner storage modulus early-stage variation ratio ((G′10(w)/G′0(w))/(G′10(c)/G′0(c))), is preferably in a range from 1.05 to 1.32.

When the ratio of the white toner storage modulus early-stage variation ratio to the colored toner storage modulus early-stage variation ratio is too large, sharp meltability of the colored toner is significantly low. Consequently, when a visible image (fixed image) composed of the colored toner image disposed on the white toner image is formed, heat fixing at a low temperature may be unable to perform. On the other hand, when the ratio of the white toner storage modulus early-stage variation ratio to the colored toner storage modulus early-stage variation ratio is too small, difference in sharp meltability between the white toner and the colored toner is very small. Consequently, color mixture may occur at the interface between the white toner image and the colored toner image.

Further, in the toner image stack, as represented by the above Relational Expression (2), the storage modulus G′20(w) is required to be smaller than the storage modulus G′20(c). The magnitude of the storage modulus G′20(w) to the storage modulus G′20(c), namely, a ratio of the storage modulus G′20(w) to the storage modulus G′20(c) (G′20(w)/G′20(c)), is preferably in a range from 0.32 to 0.89.

When the ratio of the storage modulus G′20(w) to the storage modulus G′20(c) is too large, low-temperature fixability of the colored toner may be significantly low. On the other hand, when the ratio of the storage modulus G′20(w) to the storage modulus G′20(c) is too small, difference in low-temperature fixability between the white toner and the colored toner is very small. Consequently, color mixture may occur at the interface between the white toner image and the colored toner image.

Further, the white toner preferably satisfies the following Relational Expression (3). That is, the white toner storage modulus early-stage variation ratio is preferably more than 0.88 and less than 1.00.

When the white toner satisfies the following Relational Expression (3), the white toner has excellent sharp meltability.

When the white toner storage modulus early-stage variation ratio is too small, difference in sharp meltability between the white toner and the colored toner is very small. Consequently, color mixture may occur at the interface between the white toner image and the colored toner image.

0.88<G′10(w)/G′0(w)<1.00 Relational Expression(3):

Further, the storage modulus G′20(w) of the white toner is preferably 2.4×10⁵ Pa or less.

When the storage modulus G′20(w) is in the above range, the white toner has excellent low-temperature fixability.

The storage moduli of the white toner and the colored toner can be controlled through compositions of the white toner and the colored toner.

In order that the white toner and the colored toner have desired storage moduli, it is preferable to use, as at least one of constituent materials of each of the white toner and the colored toner, a material having a melting point, namely, a crystalline material. In particular, it is preferable to use a crystalline resin as the binder resin. More specifically, it is far preferable, for example, to use an amorphous resin and a crystalline polyester resin as the binder resin(s); further, to use, as the crystalline polyester resin, one which has a similar polarity to that of the amorphous resin and high compatibility with the amorphous resin and/or has a low melting point; and still further, to use, as the amorphous resin, one which has a similar skeleton to that of the crystalline polyester resin and contains a large amount of alkenyl succinic acid.

In the present invention, the crystalline resin means a resin not showing stepwise endothermic change but having a clear endothermic peak in differential scanning calorimetry (DSC). The clear endothermic peak means, to be specific, a peak having a full width at half maximum of the endothermic peak of 15° C. or less measured at a temperature rising rate of 10° C./min in differential scanning calorimetry (DSC).

The amorphous resin means a resin not having a clear endothermic peak in DSC and not being a crystalline resin.

### [White Toner]

The white toner is composed of white toner particles which contain at least a binder resin and a white colorant and may contain, as needed, additives (internal additives) such as a release agent and a charge control agent. The white toner particles may constitute the white toner as they are, but, in order to improve fluidity, charge characteristics, cleanability and so forth, the white toner particles may constitute the white toner with external additives such as a fluidizer and a cleaning aid, which are so-called post treatment agents, added. That is, the white toner contains an external additive(s) added thereto as needed.

### [Binder Resin]

The binder resin of the white toner particles preferably contains a crystalline resin and far preferably contains both an amorphous resin and a crystalline resin in terms of control on the storage modulus of the white toner.

### [Crystalline Resin]

The crystalline resin in the present invention has a melting point (Tm) of preferably 40° C. to 95° C. and far preferably 50° C. to 90° C.

When the melting point of the crystalline resin is too low, heat resistance (thermal strength) of the toner is low. Consequently, sufficient heat-resistant storability and hot offset resistance may be unable to obtain. On the other hand, when the melting point of the crystalline resin is too high, sufficient low-temperature fixability may be unable to obtain.

The melting point (Tm) of the crystalline resin is a temperature at the top of the endothermic peak and measured by DSC, namely, differential scanning calorimetry, with a differential scanning calorimeter DSC-7 (from PerkinElmer Inc.) and a thermal analysis controller TAC7/DX (from PerkinElmer Inc.).

More specifically, the measurement is carried out as follows: enclose 0.5 mg of the crystalline resin in an aluminum pan (KIT NO. 0219-0041); set the aluminum pan on a sample holder of the device for DCS; perform temperature control of Heat-Cool-Heat with measurement conditions of a measurement temperature of 0° C. to 200° C., a temperature rising rate of 10° C./min and a temperature falling rate of 10° C./min; and make an analysis on the basis of data obtained in the 2^{nd} Heat. For the measurement of a reference, an empty aluminum pan is used.

The weight average molecular weight (Mw) of the crystalline resin in the present invention measured by Gel Permeation Chromatography (GPC) is preferably 5,000 to 50,000 and far preferably 10,000 to 25,000.

When the weight average molecular weight of the crystalline resin is either too large or too small, sufficient fixability may be unable to obtain.

The measurement of the molecular weight by GPC is carried out by using HLC-8120GPC (from Tosoh Co.) as a measuring device and also using the standard polystyrene calibration curve as a calibration curve.

The details are as follows. A device HLC-8220 (from Tosoh Co.) and a column TSKguardcolumn+TSKgel SuperHZM-M 3 ren (from Tosoh Co.) are used. While a column temperature is kept at 40° C., tetrahydrofuran (THF) as a carrier solvent is made to flow at a flow velocity of 0.2 mL/min. A measurement sample (crystalline polyester resin) is treated with an ultrasonic disperser for five minutes at room temperature to be dissolved in the tetrahydrofuran so as to be a concentration of 1 mg/mL. Next, the resulting product is treated with a membrane filter having a pore size of 0.2 μm so as to produce a sample solution, and 10 μL of the sample solution is poured into the device together with the above carrier solvent, the refractive index thereof is detected with a refractive index detector (RI detector), and the molecular weight distribution of the measurement sample is calculated using a calibration curve measured with monodisperse polystyrene standard particles. As standard polystyrene samples for measuring the calibration curve, those having molecular weights of 6×10², 2.1×10², 4×10², 1.75×10⁴, 5.1×10⁴, 1.1×10⁵, 3.9×10⁵, 8.6×10⁵, 2×10⁶ and 4.48×10⁶ from Pressure Chemical are usable, and at least around 10 standard polystyrene samples are measured for creating the calibration curve. In addition, as a detector, a refractive index detector is used.

Examples of the crystalline resin in the present invention include a crystalline polyester resin.

As the crystalline polyester resin, among publically-known polyester resins produced by polycondensation reaction of di- or higher-valent carboxylic acid (polycarboxylic acid) and di- or higher-valent alcohol (polyhydric alcohol), those having crystallinity are used.

The di- or higher-valent carboxylic acid (polycarboxylic acid) is a compound containing two or more carboxyl groups in one molecule.

Examples of the polycarboxylic acid for producing the crystalline polyester resin include: saturated aliphatic dicarboxylic acids such as oxalic acid, malonic acid, succinic acid, adipic acid, sebacic acid, azelaic acid, dodecanedioic acid and n-dodecyl succinic acid; alicyclic dicarboxylic acids such as cyclohexanedicarboxylic acid; aromatic dicarboxylic acids such as phthalic acid, isophthalic acid and terephthalic acid; tri- or higher-valent carboxylic acids such as trimellitic acid and pyromellitic acid; and anhydrides and C₁-C₃ alkyl esters of these carboxylic acids. These may be used individually (one type), or two or more types thereof may be mixed to use.

The di- or higher-valent alcohol (polyhydric alcohol) is a compound containing two or more hydroxy groups in one molecule.

Examples of the polyhydric alcohol for producing the crystalline polyester resin include: aliphatic diols such as 1,2-propanediol, 1,3-propanediol, 1,4-butanediol, 1,5-pentanediol, 1,6-hexanediol, 1,7-heptanediol, 1,8-octanediol, neopentylglycol, 1,4-butenediol, 1,9-nonanediol and 1,10-decanediol; and tri- or higher-valent alcohols such as glycerin, pentaerythritol, trimethylolpropane and sorbitol. These may be used individually (one type), or two or more types thereof may be mixed to use.

### [Amorphous Resin]

Examples of the amorphous resin include styrene-based resin, (meth)acrylic-based resin, styrene-(meth)acrylic-based copolymer resin and amorphous polyester resin. Among these, amorphous polyester resin is preferable because it has low viscosity and high sharp meltability as melting characteristics.

As the amorphous polyester resin, polyester resins produced by polycondensation reaction of di- or higher-valent carboxylic acid (polycarboxylic acid) and di- or higher-valent alcohol (polyhydric alcohol) except the above crystalline polyester resins and having no clear melting point (Tm) are used.

Examples of the polyhydric alcohol for producing the amorphous polyester resin include: dihydric alcohols such as ethylene glycol, propylene glycol, butanediol, diethylene glycol, hexanediol, cyclohexanediol, octanediol, decanediol, dodecanediol, ethylene oxide adduct of bisphenol A and propylene oxide adduct of bisphenol A; and tri- or higher-valent alcohols such as glycerin, pentaerythritol, hexamethylolmelamine, hexaethylolmelamine, tetramethylolbenzoguanamine and tetraethylolbenzoguanamine. These maybe used individually (one type), or two or more types thereof may be mixed to use.

Examples of the polycarboxylic acid for producing the amorphous polyester resin include: aromatic carboxylic acids such as terephthalic acid, isophthalic acid, phthalic acid, trimellitic acid, pyromellitic acid and naphthalenedicarboxylic acid; aliphatic carboxylic acids such as maleic acid, fumaric acid, succinic acid, alkenyl succinic acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid and 1,18-octadecanedicarboxylic acid; alicyclic carboxylic acids such as cyclohexanedicarboxylic acid; and lower alkyl esters and anhydrides of these acids. These may be used individually (one type), or two or more types thereof may be mixed to use.

As the polycarboxylic acid for producing the amorphous polyester resin, alkenyl succinic acids such as alkenyl succinic acid and anhydride thereof are particularly preferably used in terms of control on the storage modulus of the white toner, when the crystalline polyester resin is used as the binder resin. Using any of the alkenyl succinic acids such as alkenyl succinic acid and anhydride thereof as the polycarboxylic acid makes the amorphous polyester resin more compatible with the crystalline polyester resin because an alkenyl group is more hydrophobic than other functional groups.

Examples of the alkenyl succinic acids include: n-dodecylsuccinic acid; n-dodecenylsuccinic acid; isododecylsuccinic acid; isododecenylsuccinic acid; n-octylsuccinic acid; n-octenylsuccinic acid; and anhydrides, chlorides and lower alkyl esters having carbon numbers of 1 to 3 of these acids.

The glass transition point of the amorphous polyester resin is preferably 20° C. to 90° C.

The glass transition point (Tg) of the amorphous polyester resin is measured with a differential scanning calorimeter DSC-7 (from PerkinElmer Inc.) and a thermal analysis controller TACT/DX (from PerkinElmer Inc.).

More specifically, the glass transition point thereof is measured as follows: enclose 4.50 mg of the amorphous polyester resin in an aluminum pan (KIT NO. 0219-0041); set the aluminum pan on a sample holder of DSC-7; perform temperature control of Heat-Cool-Heat with measurement conditions of a measurement temperature of 0° C. to 200° C., a temperature rising rate of 10° C./min and a temperature falling rate of 10° C./min; obtain data in the 2^{nd} Heat; take an intersection point of an extension of a baseline before rising of the first endothermic peak with a tangent indicating the maximum inclination between the rising part of the first endothermic peak and the peak top as the glass transition point (Tg). For the measurement of a reference, an empty aluminum pan is used, and in the 1St Heat, 200° C. is kept for five minutes.

The weight average molecular weight (Mw) of the amorphous polyester resin measured by Gel Permeation Chromatography (GPC) is preferably 10,000 to 70,000 and far preferably 15,000 to 55,000.

When the weight average molecular weight of the amorphous resin is either too large or too small, sufficient fixability may be unable to obtain.

The measurement of the molecular weight of the amorphous polyester resin by GPC is carried out in the same way as the measurement of the molecular weight of the crystalline polyester resin.

### [White Colorant]

Examples of the white colorant include inorganic pigments (ground calcium carbonate, precipitated calcium carbonate, titanium dioxide, aluminum hydroxide, satin white, talc, calcium sulfate, barium sulfate, zinc oxide, magnesium oxide, magnesium carbonate, amorphous silica, colloidal silica, white carbon, kaolin, calcined kaolin, delaminated kaolin, aluminosilicate, sericite, bentonite, smectite, etc.); organic pigments (polystyrene resin particles, urea formalin resin particles, etc.); and pigments having a hollow structure such as hollow resin particles and hollow silica.

These inorganic white pigments and organic white pigments maybe used individually (one type), or two or more types thereof may be mixed to use, as the white colorant of the white toner used in the present invention.

The content ratio of the white colorant is preferably 0.5 to 20 mass % and far preferably 2 to 10 mass % in the white toner particles.

### [Release Agent]

Examples of the release agent include: hydrocarbonic waxes such as low molecular weight polyethylene wax, low molecular weight polypropylene wax, Fischer Tropsch wax, microcrystalline wax and paraffin wax; and ester waxes such as carnauba wax, pentaerythritol-behenic acid ester, behenyl behenate and behenyl citrate. These may be used individually (one type), or two or more types thereof may be mixed to use.

As the release agent, one having a melting point of 50° C. to 95° C. is preferably used in order that the white toner certainly have low-temperature fixability and releasability.

The content ratio of the release agent is preferably 2 to 20 mass %, far preferably 3 to 18 mass % and still far preferably 4 to 15 mass % in the white toner particles.

### [Charge Control Agent]

As the charge control agent, various publically-known compounds dispersible in aqueous media can be used, and examples thereof include nigrosine-based dye, metal salt of naphthenic acid, metal salt of higher fatty acid, alkoxylated amine, quaternary ammonium salt compound, azo-based metal complex, and metal salt and metal complex of salicylic acid.

The content ratio of the charge control agent is preferably 0.1 to 10 mass % and far preferably 0.5 to 5 mass % in the white toner particles.

### [External Additive]

Examples of the external additive include: inorganic oxide particles such as silica particles, alumina particles and titanium oxide particles; inorganic stearic acid compound particles such as aluminum stearate particles and zinc stearate particles; and inorganic titanic acid compound particles such as strontium titanate particles and zinc titanate particles. These may be used individually (one type), or two or more types thereof may be mixed to use.

These inorganic particles are preferably surface-treated with a silane coupling agent, a titanium coupling agent, higher fatty acid, silicone oil or the like in order to improve heat-resistant storability and environmental stability.

As the external additive, spherical organic particles having a number average primary particle diameter of about 10 to 2000 nm can also be used. Examples of the organic particles include: particles of a homopolymer such as styrene or methyl methacrylate; and particles of a copolymer of these.

The added amount of the external additive(s) in total is, to 100 parts by mass of the white toner, 0.05 to 5 parts by mass, preferably 0.1 to 3 parts by mass.

### [Colored Toner]

The colored toner is composed of colored toner particles which contain at least a binder resin and a colored colorant and may contain, as needed, additives (internal additives) such as a release agent and a charge control agent. The colored toner particles may constitute the colored toner as they are, but, in order to improve fluidity, charge characteristics, cleanability and so forth, the colored toner particles may constitute the colored toner with external additives such as a fluidizer and a cleaning aid, which are so-called post treatment agents, added. That is, the colored toner contains an external additive(s) added thereto as needed.

In other words, the colored toner contains a binder resin and a colorant for not white but a color (colored colorant) and may contain, as needed, other internal additives or external additives such as a release agent. Note that the “colored” (or “color”) in this application means, as described above, any of colors (yellow, magenta, cyan, black, etc.) except white.

### [Binder Resin]

The binder resin of the colored toner particles preferably contains a crystalline resin and far preferably contains both an amorphous resin and a crystalline resin in terms of control on the storage modulus of the colored toner.

Examples of the binder resin of the colored toner particles can be the same as those of the binder resin of the white toner particles.

### [Colored Colorant]

Examples of the colored colorant of the colored toner include the following organic and inorganic pigments of various types and various colors.

Examples of the colored colorant for black toner include carbon black, magnetic substances and iron-titanium complex oxide black. Examples of the carbon black include channel black, furnace black, acetylene black, thermal black and lamp black, and examples of the magnetic substances include ferrite and magnetite.

Examples of the colored colorant for yellow toner include: as dyes, C.I. Solvent Yellows 19, 44, 77, 79, 81, 82, 93, 98, 103, 104, 112 and 162; as pigments, C.I. Pigment Yellows 14, 17, 74, 93, 94, 138, 155, 180 and 185; and mixtures thereof.

Examples of the colored colorant for magenta toner include: as dyes, C.I. Solvent Reds 1, 49, 52, 58, 63, 111 and 122; as pigments, C.I. Pigment Reds 5, 48:1, 53:1, 57:1, 122, 139, 144, 149, 166, 177, 178 and 222; and mixtures thereof.

Examples of the colored colorant for cyan toner include: as dyes, C.I. Solvent Blues 25, 36, 60, 70, 93 and 95; as pigments, C.I. Pigment Blues 1, 7, 15, 60, 62, 66, 76 and 15:3; and mixtures thereof.

The content ratio of the colored colorant is preferably 0.5 to 20 mass % and far preferably 2 to 10 mass % in the colored toner particles.

### [Release Agent]

Examples of the release agent of the colored toner can be the same as those of the release agent of the white toner. It is particularly preferable that the colored toner use the same release agent as that used in the white toner.

The content ratio of the release agent is preferably 2 to 20 mass %, far preferably 3 to 18 mass % and still far preferably 4 to 15 mass % in the colored toner particles.

### [Charge Control Agent]

Examples of the charge control agent of the colored toner can be the same as those of the charge control agent of the white toner. It is particularly preferable that the colored toner use the same charge control agent as that used in the white toner.

The content ratio of the charge control agent is preferably 0.1 to 10 mass % and far preferably 0.5 to 5 mass % in the colored toner particles.

### [External Additive]

Examples of the external additive of the colored toner can be the same as those of the external additive of the white toner. It is particularly preferable that the colored toner use the same external additive(s) as that used in the white toner.

The added amount of the external additive(s) in total is, to 100 parts by mass of the colored toner, 0.05 to 5 parts by mass, preferably 0.1 to 3 parts by mass.

### [Method for Producing White Toner and Colored Toner]

A method for producing each of the white toner and the colored toner used in the present invention is exemplified by mixing pulverization, suspension polymerization, emulsion aggregation, dissolution suspension, and dispersion polymerization. Among these, in terms of uniformity in particle diameters and controllability on the shape, which are advantageous to high image quality and high stability, emulsion aggregation is preferably employed.

Emulsion aggregation is a method for producing toner particles by: as needed mixing a dispersion of resin particles dispersed with a surfactant or a dispersion stabilizer with a dispersion of a constituent component of toner particles, such as colorant particles; aggregating the dispersion to be a desired toner particle diameter by adding a flocculant to the dispersion; after or at the same time as the aggregating, fusing the resin particles; and controlling the shape.

The resin particles may contain internal additives such as a release agent and a charge control agent and may also be composite particles formed of two or more layers composed of resins different in composition.

Further, it is also preferable to add another type of resin particles at the above aggregating so as to make the toner particles have a core-shell structure in terms of a toner structure design.

The resin particles may be produced by emulsion polymerization, mini-emulsion polymerization, phase-transfer emulsification or the like or combination of any of these. When an internal additive(s) is contained in the resin particles, in particular, mini-emulsion polymerization is preferably used.

### [Particle Diameter of White Toner and Colored Toner]

The particle diameter of each of the white toner and the colored toner used in the present invention is preferably 3 to 10 μm in volume-based median diameter (D50).

The particle diameter of the white toner and the colored toner being in the above range ensures high image quality.

The volume-based median diameter (D50) of each of the white toner and the colored toner is measured and calculated with a measuring device constituted of Multisizer 3 (from Beckman Coulter, Inc.) connected with a computer system equipped with data processing software Software V3.51.

The measurement and calculation are carried out as follows: add and well disperse 0.02 g of a toner into 20 mL of a surfactant solution (e.g., a surfactant solution composed of a surfactant component-containing neutral detergent diluted 10 times with pure water for dispersing toner particles) and then perform ultrasonic dispersion for one minute so as to prepare a toner particle dispersion; pour this toner particle dispersion into a beaker containing ISOTON II (from Beckman Coulter, Inc.) in a sample stand with a pipette until the displayed concentration of the measuring device reaches 8%; set a measurement particle counting number and an aperture diameter in the measuring device at 25,000 and 100 μm, respectively; calculate frequency values; and take the particle diameter at 50% in volume-based cumulative fractions from the largest as the volume-based median diameter. Note that the above concentration range provides reproducible measurement values.

### [Average Circularity of White Toner and Colored Toner]

The average circularity of each of the white toner and the colored toner used in the present invention is preferably 0.930 to 1.000 and far preferably 0.950 to 0.995 in order to improve transfer efficiency.

It is possible that the smaller the average circularity is, the lower the quality of a formed visible image is.

The average circularity is an average value of values of the circularity calculated by the following Formula (1). The circularity is measured with, for example, FPIA-2100 (from Sysmex Co.).

Circularity T=Circle Circumference Obtained from Equivalent Circle Diameter/Perimeter of Projected Particle Image Formula (1):

### [Developer]

The white toner and the colored toner used in the present invention may be each used as a magnetic or nonmagnetic one-component developer or as a two-component developer composed of the toner mixed with carriers.

When the white toner and the colored toner used in the present invention are each used as a two-component developer, the carriers may be magnetic particles of a publically-known material. Examples thereof include: metals such as iron, ferrite and magnetite; and alloys of these metals with other metals such as aluminum and lead. In particular, ferrite particles are preferable.

Further, the carriers may be coated carriers composed of magnetic particles the surface of which is coated with a coating agent such as a resin, or may be binder carriers composed of magnetic powders dispersed in a binder resin.

Examples of the coating resin of the coated carriers include but are not limited to olefin-based resin, styrene-based resin, styrene-acrylic-based resin, silicone-based resin, ester resin and fluorine resin.

Examples of the binder resin of the dispersed-in-resin carriers (binder carriers) include but are not limited to publically-known resins such as styrene-acrylic-based resin, polyester resin, fluorine resin and phenol resin.

The volume-based median diameter of the carriers is preferably 20 to 100 μm and far preferably 20 to 60 μm.

The volume-based median diameter of the carriers is measurable, for example, with a laser diffraction particle size analyzer HELOS (from Sympatec Inc.) provided with a wet-type disperser.

### [Recording Medium]

As the recording medium, any appropriate one can be used, and examples thereof include plain paper from thin paper to thick paper, high-quality paper, coated printing paper such as art paper and coated paper, commercially-available Japanese paper, post cards, synthetic paper, films and cloth. Among these, synthetic paper and films are preferable.

Examples of the synthetic paper include polypropylene synthetic paper, and examples of the films include a polyethylene terephthalate film (PET film), a polyethylene naphthalate film and a polyimide film.

The color of the recording medium is preferably a color which requires a white background (base layer) in terms of visibility. To be specific, the recording medium is preferably colorless and transparent, or not white but colored.

### [Image Forming Apparatus]

An image forming apparatus employing the image forming method of the present invention is exemplified by a cycle type image forming apparatus which includes: one image holder; and a plurality (five or more in a full-color image forming apparatus) of development devices filled with developers of respective colors (multiple colors including white, to be specific) arranged around the image holder, wherein toner images of the respective colors are formed on the image holder and successively transferred to an intermediate transfer body or the like so as to be disposed on top of each other, and then transferred and fixed to an image support (recording medium), thereby forming a visible image (fixed image).

The image forming apparatus employing the image forming method of the present invention is also exemplified by a tandem-drum type image forming apparatus which includes image forming units of respective colors (multiple colors including white, to be specific) each having a development device and an image holder, wherein toner images are formed on the respective image holders and successively transferred to an intermediate transfer body so as to be disposed on top of each other, and then transferred and fixed to an image support (recording medium), thereby forming a visible image (fixed image).

In the image forming method of the present invention, the white toner and the colored toner the storage moduli of which have a specific relationship are used in combination, whereby thermal responsiveness of the white toner and the colored toner is controlled. Consequently, when a visible image (fixed image) composed of a colored toner image disposed on a white toner image is formed, color mixture at the interface between the white toner image and the colored toner image can be prevented from occurring, and also low-temperature fixing can be performed. Accordingly, heat fixing can be performed at a low temperature, and also a visible image the color(s) of which comes out very well can be produced.

Thus, according to the image forming method of the present invention, even when a recording medium is not white, and a colored toner image is formed on a base layer composed of a white toner image, image formation can be sped up, and a visible image having wide color gamut can be produced at high speed.

In the above, an embodiment of the present invention is detailed. However, the present invention is not limited thereto, and various modifications can be made.

### EXAMPLES

Hereinafter, the present invention is detailed with Examples. However, the present invention is not limited thereto.

### Preparation Example 1 of Amorphous Resin Particle Dispersion

### (1) Synthesis of Amorphous Resin [A]

74 parts by mass of terephthalic acid (TPA), 9 parts by mass of trimellitic acid (TMA), 16 parts by mass of fumaric acid (FA), 95 parts by mass of dodecenylsuccinic anhydride (DDSA), 381 parts by mass of propylene oxide adduct of bisphenol A (BPA.PO), and 62 parts by mass of ethylene oxide adduct of bisphenol A (BPA.EO) were fed into a reaction vessel fitted with a stirring device, a thermometer, a cooling tube and a nitrogen gas introducing tube, the air in the reaction vessel was replaced by a dry nitrogen gas, and thereafter 0.1 parts by mass of titanium tetrabutoxide was added, and the resulting product was subjected to polymerization reaction for eight hours while being stirred at 180° C. under the nitrogen gas stream. Then, 0.2 parts by mass of titanium tetrabutoxide was added thereto, and the resulting product was subjected to polymerization reaction for six hours while being stirred at 220° C., and thereafter the pressure in the reaction vessel was reduced to 10 mmHg, and reaction was conducted under the reduced pressure. Thus, a transparent pale yellow amorphous resin [A] was produced.

The glass transition point (Tg) of the produced amorphous resin [A] was 59° C., and the weight average molecular weight (Mw) thereof was 18,000.

### (2) Preparation of Amorphous Resin Particle Dispersion [A]

200 parts by mass of the amorphous resin [A] was dissolved in 200 parts by mass of ethyl acetate, and while this solution was stirred, an aqueous solution composed of sodium polyoxyethylene laurylether sulfate dissolved in 800 parts by mass of deionized water to be a concentration of 1 mass % was slowly dripped. Under the reduced pressure, ethyl acetate was removed from this solution, pH thereof was adjusted to 8.5 with ammonia, and thereafter the solid content concentration thereof was adjusted to 20 mass %. Thus, an amorphous resin particle dispersion [A] composed of particles of an amorphous resin [A] dispersed in an aqueous medium was prepared.

In the produced amorphous resin particle dispersion [A], the volume-based median diameter of the particles of the amorphous resin [A] was 230 nm.

### Preparation Examples 2 to 5 of Amorphous Resin Particle Dispersions

Amorphous resins [B] to [E] were produced in the same way as the amorphous resin [A] except that terephthalic acid (TPA), trimellitic acid (TMA), fumaric acid (FA), dodecenylsuccinic anhydride (DDSA), propylene oxide adduct of bisphenol A (BPA.PO) and ethylene oxide adduct of bisphenol A (BPA.EO) were fed with the feed amounts shown in TABLE 1. Further, amorphous resin particle dispersions [B] to [E] were prepared in the same way as the amorphous resin particle dispersion [A] except that the amorphous resins [B] to [E] were used instead of the amorphous resin [A].

The glass transition points (Tg) and the weight average molecular weights (Mw) of the produced amorphous resins [B] to [E] are shown in TABLE 1.

In the produced amorphous resin particle dispersions [B] to [E], the volume-based median diameters of the particles of the amorphous resins [B] to [E] were all 230 nm.

TABLE 1

| | | | | | | | | GLASS | WEIGHT |
|---|---|---|---|---|---|---|---|---|---|
| | TPA | TMA | FA | DDSA | | BPA · PO | BPA · EO | TRANSITION | AVERAGE |
| | [parts by | [parts by | [parts by | [parts by | [percent | [parts by | [parts by | POINT | MOLECULAR |
| | mass] | mass] | mass] | mass] | by mass] | mass] | mass] | [° C.] | WEIGHT |
| AMORPHOUS | 74 | 9 | 16 | 95 | 14.9 | 381 | 62 | 59 | 18000 |
| RESIN (A) | | | | | | | | | |
| AMORPHOUS | 62 | 7 | 13 | 111 | 17.5 | 381 | 62 | 55 | 23000 |
| RESIN (B) | | | | | | | | | |
| AMORPHOUS | 38 | 4 | 8 | 143 | 22.5 | 381 | 62 | 50 | 20000 |
| RESIN (C) | | | | | | | | | |
| AMORPHOUS | 109 | 13 | 23 | 48 | 7.5 | 381 | 62 | 66 | 28000 |
| RESIN (D) | | | | | | | | | |
| AMORPHOUS | 85 | 10 | 18 | 80 | 12.6 | 381 | 62 | 62 | 22000 |
| RESIN (E) | | | | | | | | | |

### Preparation Example 1 of Crystalline Resin Particle Dispersion

### (1) Synthesis of Crystalline Resin [a]

315 parts by mass of dodecanedioic acid and 220 parts by mass of 1,9-nonanediol were fed into a reaction vessel fitted with a stirring device, a thermometer, a cooling tube and a nitrogen gas introducing tube, the air in the reaction vessel was replaced by a dry nitrogen gas, and thereafter 0.1 parts by mass of titanium tetrabutoxide was added, and the resulting product was subjected to polymerization reaction for eight hours while being stirred at 180° C. under the nitrogen gas stream. Then, 0.2 parts by mass of titanium tetrabutoxide was added thereto, and the resulting product was subjected to polymerization reaction for six hours while being stirred at 220° C., and thereafter the pressure in the reaction vessel was reduced to 10 mmHg, and reaction was conducted under the reduced pressure. Thus, a crystalline resin [a] was produced.

The melting point (Tm) of the produced crystalline resin [a] was 68° C., and the weight average molecular weight (Mw) thereof was 14,000.

### (2) Preparation of Crystalline Resin Particle Dispersion [a]

200 parts by mass of the crystalline resin [a] was dissolved in 200 parts by mass of ethyl acetate which was heated to 70°, and the resulting product was mixed with an aqueous solution composed of sodium polyoxyethylene laurylether sulfate dissolved in 800 parts by mass of deionized water to be a concentration of 1 mass % and dispersed therein with an ultrasonic homogenizer. Under the reduced pressure, ethyl acetate was removed from this solution, and thereafter the solid content concentration thereof was adjusted to 20 mass %. Thus, a crystalline resin particle dispersion [a] composed of particles of a crystalline resin [a] dispersed in an aqueous medium was prepared.

In the produced crystalline resin particle dispersion [a], the volume-based median diameter of the particles of the crystalline resin [a] was 210 nm.

### Preparation Examples 2 to 7 of Crystalline Resin Particle Dispersions

Crystalline resins [b] to [g] were produced in the same way as the crystalline resin [a] except that, as polycarboxylic acid and polyhydric alcohol, those having carbon numbers shown in TABLE 2 were used, and the molecular weight (weight average molecular weight) was adjusted. Further, crystalline resin particle dispersions [b] to [g] were prepared in the same way as the crystalline resin particle dispersion [a] except that the crystalline resins [b] to [g] were used instead of the crystalline resin [a].

The melting points (Tm) and the weight average molecular weights (Mw) of the produced crystalline resins [b] to [g] are shown in TABLE 2.

In the produced crystalline resin particle dispersions [b] to [g], the volume-based median diameters of the particles of the crystalline resins [b] to [g] were all 210 nm.

TABLE 2

| | CARBON | | | |
|---|---|---|---|---|
| | NUMBER OF | CARBON | | WEIGHT |
| | POLYHYDRIC | NUMBER OF | MELTING | AVERAGE |
| | ALCOHOL | POLYCARBOXYLIC | POINT | MOLECULAR |
| | COMPOUND | ACID COMPOUND | [° C.] | WEIGHT |
| CRYSTALLINE | 9 | 12 | 68 | 14000 |
| POLYESTER RESIN (a) | | | | |
| CRYSTALLINE | 9 | 12 | 65 | 10000 |
| POLYESTER RESIN (b) | | | | |
| CRYSTALLINE | 9 | 12 | 63 | 5000 |
| POLYESTER RESIN (c) | | | | |
| CRYSTALLINE | 6 | 12 | 69 | 20000 |
| POLYESTER RESIN (d) | | | | |
| CRYSTALLINE | 6 | 10 | 61 | 25000 |
| POLYESTER RESIN (e) | | | | |
| CRYSTALLINE | 9 | 12 | 72 | 30000 |
| POLYESTER RESIN (f) | | | | |
| CRYSTALLINE | 10 | 12 | 75 | 14000 |
| POLYESTER RESIN (g) | | | | |

### Preparation Example 1 of Colored Colorant Particle Dispersion

50 parts by mass of copper phthalocyanine (C.I. Pigment Blue 15:3) was poured in a surfactant solution composed of sodium alkyl diphenyl ether disulfonate dissolved in 200 parts by mass of deionized water to be a concentration of 1 mass %, and dispersed with an ultrasonic homogenizer. The solid content concentration of the solution was adjusted to 20 mass %. Thus, a colored colorant particle dispersion [1] of colored colorant particles dispersed in an aqueous medium was prepared.

The volume-based median diameter of the colored colorant particles in the colored colorant particle dispersion [1] was measured with a Microtrac particle diameter analyzer UPA-150 (from Nikkiso Co., Ltd.), and it was 150 nm.

### Preparation Example 1 of White Colorant Particle Dispersion

210 parts by mass of rutile-type titanium oxide (from Ishihara Sangyo Kaisha, Ltd.) was poured in a surfactant solution composed of sodium alkyl diphenyl ether disulfonate dissolved in 482 parts by mass of deionized water to be a concentration of 1 mass %, and dispersed with an ultrasonic homogenizer. The solid content concentration of the solution was adjusted to 30 mass %. Thus, a white colorant particle dispersion [1] of white colorant particles dispersed in an aqueous medium was prepared. The volume-based median diameter of the white colorant particles in the white colorant particle dispersion [1] was 200 nm.

### Preparation Example 1 of Release Agent Particle Dispersion

200 parts by mass of Fischer-Tropsch wax FNP-0090 (melting point of 89° C., from Nippon Seiro Co., Ltd.) as a release agent was heated to 95° C. to melt. This resulting product was poured in a surfactant solution composed of sodium alkyl diphenyl ether disulfonate dissolved in 800 parts by mass of deionized water to be a concentration of 3 mass o, and dispersed with an ultrasonic homogenizer. The solid content concentration of the solution was adjusted to 20 mass %. Thus, a release agent particle dispersion [1] of release agent particles dispersed in an aqueous medium was prepared.

The volume-based median diameter of the release agent particles in the release agent particle dispersion [1] was measured with a Microtrac particle diameter analyzer UPA-150 (from Nikkiso Co., Ltd.), and it was 190 nm.

### Production Example 1 of Colored Toner (Cyan Toner)

70.8 parts by mass of the amorphous resin particle dispersion [E], 86.4 parts by mass of the crystalline resin particle dispersion [a], 13.2 parts by mass of the release agent particle dispersion [1], 11.5 parts by mass of the colored colorant particle dispersion [1], 45 parts by mass of deionized water, and 0.5 parts by mass of sodium polyoxyethylene laurylether sulfate were poured into a reaction vessel fitted with a stirring device, a thermometer and a cooling tube, and while the resulting product was stirred, 0.1N hydrochloric acid was added thereto to adjust pH to 2.5. Next, 0.4 parts by mass of a polyaluminum chloride solution (10% solution in terms of AlCl₃) was dripped taking 10 minutes, and thereafter the temperature was increased at 0.5° C./min while the resulting product was stirred, and the particle diameter of the aggregate particles was appropriately measured with Multisizer 3 (from Beckman Coulter, Inc.). When the volume-based median diameter of the aggregate particles reached 4.5 μm, the temperature increase was stopped, and a solution composed of (i) a mixed solution which is composed of 275.4 parts by mass of the amorphous resin particle dispersion [E], 51.8 parts by mass of the release agent particle dispersion [1], 45.8 parts by mass of the colored colorant particle dispersion [1], 180 parts by mass of deionized water, and 2.0 parts by mass of sodium polyoxyethylene laurylether sulfate, and (ii) a 0.1N sodium hydroxide solution added to the mixed solution so as to adjust pH to 5 was dripped taking one hour. The temperature was increased to 75° C. and the internal temperature was kept, and the particle diameter of the associated particles was measured with Multisizer 3 (from Beckman Coulter, Inc.). When the volume-based median diameter reached 6.0 μm, 2 parts by mass of a 3-hydroxy-2,2′-iminodisuccinic acid tetrasodium solution (40% solution) was added to stop the particle growth. The internal temperature was increased to 85° C., and when the average circularity measured with FPIA-2100 (from Sysmex Co.) reached 0.960, the temperature was decreased to room temperature at 10° C./min. This reaction solution was repeatedly subjected to filtration and washing and then dried. Thus, colored toner particles [1] were produced.

To the produced colored toner particles [1], 1 mass % of hydrophobic silica (a number average primary particle diameter of 12 nm and a hydrophobicity of 68) and 1 mass % of hydrophobic titanium oxide (a number average primary particle diameter of 20 nm and a hydrophobicity of 63) were added and mixed therewith with a Henschel mixer (from Mitsui Miike Kakouki Kabushiki Kaisha) and then filtered through a mesh sieve having an opening of 45 μm to remove coarse particles. Thus, a colored toner [1] was produced.

The volume-based median diameter of the produced colored toner [1] was 6.10 μm, and the average circularity thereof was 0.965.

The storage modulus G′0(c) of the produced colored toner [1] was 3.9×10⁵ Pa, the storage modulus G′10(c) thereof was 3.0×10⁵ Pa, and the storage modulus G′20(c) thereof was 2.8×10⁵ Pa.

### Production Example 1 of White Toner

70.8 parts by mass of the amorphous resin particle dispersion [A], 86.4 parts by mass of the crystalline resin particle dispersion [a], 13.2 parts by mass of the release agent particle dispersion [1], 11.5 parts by mass of the white colorant particle dispersion [1], 45 parts by mass of deionized water, and 0.5 parts by mass of sodium polyoxyethylene laurylether sulfate were poured into a reaction vessel fitted with a stirring device, a thermometer and a cooling tube, and while the resulting product was stirred, 0.1N hydrochloric acid was added thereto to adjust pH to 2.5. Next, 0.3 parts by mass of a polyaluminum chloride solution (10% solution in terms of AlCl₃) was dripped taking 10 minutes, and thereafter the temperature was increased at 0.5° C./min while the resulting product was stirred, and the particle diameter of the aggregate particles was appropriately measured with Multisizer 3 (from Beckman Coulter, Inc.). When the volume-based median diameter of the aggregate particles reached 4.5 μm, the temperature increase was stopped, and a solution composed of (i) a mixed solution which is composed of 275.4 parts by mass of the amorphous resin particle dispersion [A], 51.8 parts by mass of the release agent particle dispersion [1], 45.8 parts by mass of the white colorant particle dispersion [1], 180 parts by mass of deionized water, and 2.0 parts by mass of sodium polyoxyethylene laurylether sulfate, and (ii) a 0.1N sodium hydroxide solution added to the mixed solution so as to adjust pH to 5 was dripped taking one hour. The temperature was increased to 75° C. and the internal temperature was kept, and the particle diameter of the associated particles was measured with Multisizer 3 (from Beckman Coulter, Inc.). When the volume-based median diameter reached 6.0 μm, 2 parts by mass of a 3-hydroxy-2,2′-iminodisuccinic acid tetrasodium solution (40% solution) was added to stop the particle growth. The internal temperature was increased to 85° C., and when the average circularity measured with FPIA-2100 (from Sysmex Co.) reached 0.960, the temperature was decreased to room temperature at 10° C./min. This reaction solution was repeatedly subjected to filtration and washing and then dried. Thus, white toner particles [1] were produced.

To the produced white toner particles [1], 1 mass % of hydrophobic silica (a number average primary particle diameter of 12 nm and a hydrophobicity of 68) and 1 mass % of hydrophobic titanium oxide (a number average primary particle diameter of 20 nm and a hydrophobicity of 63) were added and mixed therewith with a Henschel mixer (from Mitsui Miike Kakouki Kabushiki Kaisha) and then filtered through a mesh sieve having an opening of 45 μm to remove coarse particles. Thus, a white toner [1] was produced.

The storage modulus G′0(w) of the produced white toner [1] was 2.7×10⁵ Pa, the storage modulus G′10(w) thereof was 2.4×10⁵ Pa, and the storage modulus G′20(w) thereof was 2.4×10⁵ Pa.

### Production Examples 2 to 11 of White Toners

White toner particles [2] to [11] were produced in the same way as the white toner particles [1] except that, as the amorphous resin and the crystalline resin, those shown in TABLE 3 were used, and white toners [2] to [11] were produced in the same way as the white toner [1] except that the produced white toner particles [2] to [11] were used instead of the white toner particles [1].

The storage moduli G′0(w), the storage moduli G′10(w) and the storage moduli G′20(w) of the produced white toners [1] to [11] are shown in TABLE 4.

TABLE 3

| | AMORPHOUS RESIN | CRYSTALLINE POLYESTER RESIN |
|---|---|---|
| WHITE TONER (1) | AMORPHOUS RESIN (A) | CRYSTALLINE POLYESTER RESIN (a) |
| WHITE TONER (2) | AMORPHOUS RESIN (A) | CRYSTALLINE POLYESTER RESIN (b) |
| WHITE TONER (3) | AMORPHOUS RESIN (A) | CRYSTALLINE POLYESTER RESIN (c) |
| WHITE TONER (4) | AMORPHOUS RESIN (A) | CRYSTALLINE POLYESTER RESIN (d) |
| WHITE TONER (5) | AMORPHOUS RESIN (A) | CRYSTALLINE POLYESTER RESIN (e) |
| WHITE TONER (6) | AMORPHOUS RESIN (B) | CRYSTALLINE POLYESTER RESIN (a) |
| WHITE TONER (7) | AMORPHOUS RESIN (C) | CRYSTALLINE POLYESTER RESIN (a) |
| WHITE TONER (8) | AMORPHOUS RESIN (A) | CRYSTALLINE POLYESTER RESIN (f) |
| WHITE TONER (9) | AMORPHOUS RESIN (A) | CRYSTALLINE POLYESTER RESIN (g) |
| WHITE TONER (10) | AMORPHOUS RESIN (D) | CRYSTALLINE POLYESTER RESIN (a) |
| WHITE TONER (11) | AMORPHOUS RESIN (E) | CRYSTALLINE POLYESTER RESIN (a) |
| COLORED TONER (1) | AMORPHOUS RESIN (E) | CRYSTALLINE POLYESTER RESIN (a) |

### Examples 1 to 7 and Comparative Examples 1 to 4

Using the white toners and the colored toner shown in TABLE 4, saturation and low-temperature fixability were evaluated as follows. The result is shown in TABLE 4.

### [Saturation]

On a 120 μm thick transparent PET film, a solid toner image having a size of 20 cm×20 cm and a toner-deposited amount of 4.5 g/m² was formed with each white toner, and on this solid toner image, a solid toner image having a size of 2 cm×2 cm and a toner-deposited amount of 4.5 g/m² was formed with the colored toner. Then, the solid toner image of the white toner and the solid toner image of the colored toner formed on the transparent PET film were together fixed thereto with a single fixing device provided with a fixing-heating belt the set temperature of which was 180° C., thereby producing a fixed image.

The produced fixed image was disposed on black paper, and the saturation of the colored toner image on the white toner image was measured with Macbeth Color-Eye 7000 (from Macbeth). The higher the saturation is, the higher it is evaluated.

### [Low-Temperature Fixability]

An evaluation device was prepared as follows; a full-color copier bizhub PRO C6500 (from Konica Minolta Business Technologies, Inc.) was modified in such a way that the surface temperature of a fixing roller of a fixing device was changeable in a temperature range from 100° C. to 210° C.

With the prepared evaluation device, a fixing test to fix a toner image having a toner-deposited amount of 4 mg/10 cm² to A4 plain paper (a basis weight of 80 g/m²) was repeatedly conducted while the surface temperature of the fixing roller of the fixing device was increased in 5° C. segments from 100° C. to 105° C., and so forth. In the fixing test of each white toner, black plain paper was used, whereas in the fixing test of the colored toner, white plain paper was used.

The recording medium on which the produced fixed image (solid image) was formed was folded with a folding machine in such a way that a load was applied to the fixed image, and 0.35 MPa compressed air was blown thereto. Then, the crease was evaluated according to the following criteria. The fixing temperature with which Rank 3 among five ranks below was achieved in the fixing test was taken as the lower limit fixing temperature. When the lower limit fixing temperature was 165° C. or lower, the toner passed the text.

### (Evaluation Criteria)

Rank 5: no crease at all

Rank 4: partial separation along the crease

Rank 3: separation in the shape of thin lines along the crease

Rank 2: separation in the shape of thick lines along the crease

Rank 1: large separation

TABLE 4

| | | | | | | | | | | | | | LOWER LIMIT | | |
|---|---|---|---|---|---|---|---|---|---|---|---|---|---|---|---|
| | | | | | | | | | | | | | FIXING | | |
| | | | | | | | | | | | | | TEMPERATURE | | |
| | WHITE TONER | COLORED TONER | G′0(w) [Pa] | G′10(w) [Pa] | $\frac{{G}^{′} 10 ( w )}{{G}^{′} 0 ( w )}$ | G'20(w) [Pa] | G′0(c) [Pa] | G′10(c) [Pa] | $\frac{{G}^{′} 10 ( c )}{{G}^{′} 0 ( c )}$ | G′20(c) [Pa] | $\frac{\frac{{G}^{′} 10 ( w )}{{G}^{′} 0 ( w )}}{\frac{{G}^{′} 10 ( c )}{{G}^{′} 0 ( c )}}$ | $\frac{{G}^{′} 20 ( w )}{{G}^{′} 20 ( c )}$ | WHITE TONER | COLORED TONER | SATURATION |
| *A1 | WHITE | COLORED | 2.7 × 10⁵ | 2.4 × 10⁵ | 0.89 | 2.4 × 10⁵ | 3.9 × 10⁵ | 3.0 × 10⁵ | 0.77 | 2.8 × 10⁵ | 116 | 0.86 | 160° C. | 165° C. | 60 |
| | TONER (1) | TONER (1) | | | | | | | | | | | | | |
| *A2 | WHITE | COLORED | 2.4 × 10⁵ | 2.2 × 10⁵ | 0.92 | 2.2 × 10⁵ | 3.9 × 10⁵ | 3.0 × 10⁵ | 0.77 | 2.8 × 10⁵ | 1.19 | 0.79 | 158° C. | 165° C. | 62 |
| | TONER (2) | TONER (1) | | | | | | | | | | | | | |
| *A3 | WHITE | COLORED | 1.2 × 10⁵ | 1.1 × 10⁵ | 0.92 | 1.1 × 10⁵ | 3.9 × 10⁵ | 3.0 × 10⁵ | 0.77 | 2.8 × 10⁵ | 1.19 | 0.39 | 150° C. | 165° C. | 65 |
| | TONER (3) | TONER (1) | | | | | | | | | | | | | |
| *A4 | WHITE | COLORED | 2.2 × 10⁵ | 2.0 × 10⁵ | 0.91 | 2.0 × 10⁵ | 3.9 × 10⁵ | 3.0 × 10⁵ | 0.77 | 2.8 × 10⁵ | 1.18 | 0.71 | 155° C. | 165° C. | 63 |
| | TONER (4) | TONER (1) | | | | | | | | | | | | | |
| *A5 | WHITE | COLORED | 9.0 × 10⁴ | 9.0 × 10⁴ | 1.00 | 9.0 × 10⁴ | 3.9 × 10⁵ | 3.0 × 10⁵ | 0.77 | 2.8 × 10⁵ | 1.30 | 0.32 | 145° C. | 165° C. | 68 |
| | TONER (5) | TONER (1) | | | | | | | | | | | | | |
| *A6 | WHITE | COLORED | 3.3 × 10⁵ | 2.7 × 10⁵ | 0.82 | 2.4 × 10⁵ | 3.9 × 10⁵ | 3.0 × 10⁵ | 0.77 | 2.8 × 10⁵ | 1.06 | 0.86 | 153° C. | 165° C. | 63 |
| | TONER (6) | TONER (1) | | | | | | | | | | | | | |
| *A7 | WHITE | COLORED | 2.8 × 10⁵ | 2.5 × 10⁵ | 0.89 | 0.9 × 10⁵ | 3.9 × 10⁵ | 3.0 × 10⁵ | 0.77 | 2.8 × 10⁵ | 1.16 | 0.32 | 148° C. | 165° C. | 66 |
| | TONER (7) | TONER (1) | | | | | | | | | | | | | |
| *B1 | WHITE | COLORED | 3.6 × 10⁵ | 3.2 × 10⁵ | 0.89 | 3.0 × 10⁵ | 3.9 × 10⁵ | 3.0 × 10⁵ | 0.77 | 2.8 × 10⁵ | 1.16 | 1.07 | 168° C. | 165° C. | 48 |
| | TONER (8) | TONER (1) | | | | | | | | | | | | | |
| *B2 | WHITE | COLORED | 4.0 × 10⁵ | 2.8 × 10⁵ | 0.70 | 2.4 × 10⁵ | 3.9 × 10⁵ | 3.0 × 10⁵ | 0.77 | 2.8 × 10⁵ | 0.91 | 0.86 | 175° C. | 165° C. | 43 |
| | TONER (9) | TONER (1) | | | | | | | | | | | | | |
| *B3 | WHITE | COLORED | 4.9 × 10⁵ | 3.4 × 10⁵ | 0.69 | 3.0 × 10⁵ | 3.9 × 10⁵ | 3.0 × 10⁵ | 0.77 | 2.8 × 10⁵ | 0.90 | 1.07 | 180° C. | 165° C. | 40 |
| | TONER (10) | TONER (1) | | | | | | | | | | | | | |
| *B4 | WHITE | COLORED | 4.5 × 10⁵ | 3.3 × 10⁵ | 0.73 | 2.9 × 10⁵ | 3.9 × 10⁵ | 3.0 × 10⁵ | 0.77 | 2.8 × 10⁵ | 0.95 | 1.04 | 165° C. | 165° C. | 40 |
| | TONER (11) | TONER (1) | | | | | | | | | | | | | |

*A: EXAMPLE
*B: COMPARATIVE EXAMPLE

This application is based upon and claims the benefit of priority under 35 USC 119 of Japanese Patent Application No. 2014-121353 filed Jun. 12, 2014, the entire disclosure of which, including the specification, claims and abstract, is incorporated herein by reference in its entirety.

What is claimed is:

1. An image forming method comprising:
disposing a white toner image of a white toner containing a binder resin and a white colorant and a colored toner image of a colored toner containing a binder resin and a colored colorant on a recording medium in the order named; and
heat-fixing the white toner image and the colored toner image, which is disposed on the white toner image, to the recording medium, wherein
the white toner and the colored toner satisfy the following relational expressions (1) and (2):
(G′10(c)/G′0(c))<(G′10(w)/G′0(w)); and Relational Expression (1):
G′20(w)<G′20(c), Relational Expression (2):
wherein G′0(w) represents a storage modulus of the white toner 0 seconds after start of time variance measurement, G′10(w) represents a storage modulus of the white toner 10 seconds after the start, G′20(w) represents a storage modulus of the white toner 20 seconds after the start, G′0(c) represents a storage modulus of the colored toner 0 seconds after the start, G′10(c) represents a storage modulus of the colored toner 10 seconds after the start, and G′20(c) represents a storage modulus of the colored toner 20 seconds after the start, the storage moduli being obtained by the time variance measurement at 90° C.

2. The image forming method according to claim 1, wherein the white toner satisfies the following relational expression (3):
0.88<G′10(w)/G′0(w)<1.00. Relational Expression (3):

3. The image forming method according to claim 1, wherein the G′20(w) is 2.4×10⁵ Pa or less.

4. The image forming method according to claim 1, wherein each of the binder resin of the white toner and the binder resin of the colored toner contains a crystalline resin.

5. The image forming method according to claim 1, wherein the recording medium is a film or synthetic paper.
